(19) United States
(12) Patent Application Publication
(10) Pub. No.: US 2010/0310803 A1
(43) Pub. Date: Dec. 9, 2010

(54) COMPOSITE PRODUCTS AND METHODS OF MAKING SAME

(75) Inventor: Neil Edwin Wallace, New South Wales (AU)

Correspondence Address: MICHAEL BEST & FRIEDRICH LLP, 100 E WISCONSIN AVENUE, Suite 3300, MILWAUKEE, WI, 53202, US

(73) Assignee: BLUESCOPE STEEL LIMITED, Melbourne, Victoria (AU)

(21) Appl. No.: 12/745,637

(22) PCT Filed: Nov. 28, 2008
(86) PCT No.: PCT/AU08/01770

§ 371 Date: Jul. 8, 2010

(30) Foreign Application Priority Data
Nov. 29, 2007 (AU) 2007906519

(51) Int. Cl. B29D 23/00; B29C 39/10

(52) U.S. Cl. 428/36.9; 264/500; 264/259

(57) ABSTRACT

A method of forming a polymeric component on a body is disclosed which includes the steps of casting a fluid polymeric material onto the body whilst providing support for the body. The method has particular application to casting components on metal pipes and the like.

### FIELD OF THE INVENTION

The present invention relates generally to composite products and to methods of making such products. The invention has particular application to composite products that include a polymeric component that is formed on a body formed of sheet material. The invention is described with reference to composite products for water infrastructure (such as pipes, channels, water detention or retention systems, and tanks) that are made principally from steel strip that incorporates a corrosion resistant metal coating and in some arrangements a polymeric film overlay. However, it is to be appreciated that the invention has broader application and is not limited in that use.

### BACKGROUND OF THE INVENTION

It has been found beneficial in at least some instances to form products such as water infrastructure products, as a composite construction where a polymeric component is connected to the product body made typically from sheet metal. This component may serve a variety of purposes. For example, the component may provide at least part of a coupling to allow the product body to be connected to another component to forming a watertight seal at the coupling. In another example, the polymeric component may be used as part of a base or lid structure for a water tank or detention/retention system.

In the applicant's earlier International application WO2007/073579 entitled “Method of Making a Composite Product”, the contents of which are herein incorporated by cross reference, there is disclosed methods for making such composite products by direct casting of the polymeric components onto the product body.

Whilst such techniques have been found beneficial, the strength of the host body may represent a limiting factor in the level of fluid pressure that may be introduced into the cavity during casting. This in turn can restrict either or both of the material that may be suitable for the host body, particularly where the body is made from relatively thin sheet material (such as sheet steel in the order of 0.5 mm to 1.00 mm), or the operating conditions of the casting process.

### SUMMARY OF THE INVENTION

In a first aspect there is provided a method of forming a polymeric component on a body comprising the steps of:

casting fluid polymeric material onto the body whilst providing support for said body; and

providing conditions suitable to cause hardening of the polymeric material to form the polymeric component as a casting on the body.

In the context of the specification, the term “cast” or variations such as “casting” and the like as used in relation to the polymeric components includes all moulding techniques and/or resulting articles formed by such techniques, where the polymeric material is introduced into a mould so as to form the component into a particular shape. The material may be introduced into the mould by any suitable method such as via an injection moulding process or by an extruder feed arrangement.

In a particular form, the body is supported by providing fluid pressure on opposite sides of the body. According to this arrangement, the total fluid pressure that can be introduced into the cavity is not dependent on the strength of the body as during casting there is some balancing of the fluid pressure on the opposite sides of the body. With this arrangement the body is required to accommodate the differential in the fluid pressure on the opposite sides of the body during casting.

In a particular form, the fluid pressure on the opposite sides of the body is substantially equal.

In one form, the fluid polymeric is cast only onto one side of the body, whereas another fluid is provided on the other side. The fluid may be pressurised air or the like. In another form, the polymeric material is cast on the opposite sides of said body so as to provide fluid pressure on those opposite sides.

In a particular form, at least one aperture is located in the body to allow the fluid polymeric material to flow between the opposite sides so as to balance the fluid pressure being applied to the opposite sides during casting.

In one form, the method further comprising the steps of providing a mould cavity having a cavity part on each of the opposite sides of the body; the mould cavity parts being interconnected by said at least one aperture; and introducing the fluid polymeric material into at least one of the cavity parts so that the fluid polymeric material is able to flow between the cavity parts via the at least one aperture.

In one form, the body is formed from sheet material.

In a further aspect, there is provided a method of forming a polymeric component on a body formed from sheet material, the method comprising the steps of: providing at least one aperture in the body; providing a mould cavity having a cavity part on each of opposite sides of the sheet body; the mould cavity parts being interconnected by the at least one aperture; introducing a fluid polymeric material into at least one of the cavities so that the fluid polymeric material is able to flow between the cavity parts via the at least one aperture; and providing conditions suitable to cause hardening of the polymeric material to form the polymeric component as a casting on the body.

In a particular form, the mould is provided by first and second mould parts that are disposed on the respective ones of the opposite sides of the body. In one form, one of the first or second mould parts is arranged to support the body during casting.

In one form each of the mould parts define a mould cavity part.

In a particular form, at least one spacer is disposed on the body on which at least one of the mould parts is located. In a particular form, the at least one spacer is mounted within a respective aperture of the body. In this way the body can be supported by

A method according to any form described above is ideally suited for the casting of a polymeric component onto a sheet metal body. As such the methods disclosed are suited to manufacturing methods for water infrastructure.

In one form, the product is for water infrastructure and the body is in the form of a pipe with a closed section. In a particular form, the pipe includes at least one external rib which extends between opposite ends of the pipe. One such pipe is formed from steel having a corrosion resistant metal coating and incorporating a polymeric film. The polymeric film not only aids in bonding of the component to the section but may be used for other purposes. For example the polymeric film may provide a moisture barrier and/or enhance the chemical resistance of the metal. Such polymeric films may include low density or high density polyethylene, PVC and polypropylene.

In one form, the body incorporates steel sheet having a thickness in the range of 0.5 mm to 1.6 mm.

In one form, the component is cast onto the body so as to form a coupling for that body. In one form, the coupling is formed at the end of the body. Alternatively it may be formed at an intermediate section of the body to provide an intermediate connection for that body.

The methods of casting according to the various forms described above may incorporate any of the additional steps disclosed in the applicant's earlier International application WO 2007/073579, and accordingly the content of that application is herein incorporated by cross reference.

In one form, the method further comprises the steps of controlling the pressure that the fluid polymeric material is introduced into the cavities. Where the body is formed from sheet metal, the pressure of the fluid polymeric material that is introduced may be in the order of 200 to 800 kpa. In one form, the pressure could be up to 2000 kpa. This is greater than the pressure range disclosed in the above mentioned earlier application and this is attributable to the balancing of the pressure on the opposite sides of the body.

In one form, the polymeric component is cast as a preform onto the body. In that arrangement the method further comprises the step of post forming the preform into its finished shape. In an alternative arrangement, the polymeric component is cast into its finished shape directly without requiring any post forming.

In a further aspect the invention is directed to a composite product comprising a body and incorporating at least one aperture extending through the body, and a polymeric component cast on at least one surface of the body, the polymeric component being cast over the at least one aperture so that the cast component extends into the at least one aperture.

In one form the polymeric component is cast on opposite sides of the body and the portions of the component on the respective sides of the body are connected through the at least one aperture.

In a particular form the component is bonded to the body surface as a result of being cast on to that surface.

In a particular form the body is formed from sheet metal and is a particular form sheet steel that incorporates a corrosion resistant metal coating. In a particular form the body incorporates a polymeric coating applied to the sheet metal that forms an intermediate layer between the metal sheet and the polymeric component.

In another form, the polymeric casting is applied directly to the metal surface or if that metal surface incorporates a corrosion resistant metal coating, the casting is applied directly onto that metal coating.

In a particular embodiment the product is for water infrastructure and the body is shaped to convey or contain water and the water impermeable interface is formed between the body and the component.

In one form the body is in the form of a pipe having a closed section. In a particular form the pipe includes at least one external stiffening formation which extends between opposite ends of the pipe.

In a particular form the polymeric component is cast onto the body so as to forma coupling for that body. In a particular form the coupling is formed at the end of the body. The purpose of the coupling is to enable products to be connected through the coupling to another product such as a water infrastructure product. The coupling is arranged to provide a watertight joint between the interconnected products and may incorporate a seal to aid the integrity of the joint to be watertight.

### BRIEF DESCRIPTION OF THE DRAWINGS

Embodiments are hereinafter described with reference to the accompanying drawings. It is to be appreciated that the particularity of the drawings and the related description is to be understood as not limiting the preceding broad description of the invention.

In the drawings:

FIGS. 1A, 1B and 1C are schematic views of various pipe couplings incorporating polymeric components used in water infrastructure;

FIG. 2 is a schematic view of a branch junction for a pipe;

FIG. 3 is a schematic sectional view of a water tank incorporating a polymeric base coupling;

FIG. 4 is a schematic side view of a moulding apparatus connected to an end of a host body;

FIG. 5 is an end view of the moulding apparatus of FIG. 4;

FIG. 6 is a schematic sectional view of the moulding apparatus connected to the host body, where that section has an external ribbed configuration;

FIG. 7 is a variation of the view of FIG. 6 where the host body is corrugated;

FIG. 8 is a further variation of a pipe coupling of FIG. 1C in an exploded view;

FIG. 9 is an assembled view of the pipe coupling of FIG. 8;

FIG. 10 is a sectional view of the pipe coupling of FIG. 8;

FIG. 11 is a sectional view of a variation on the composite product incorporating a host pipe and male coupling;

FIG. 12 is a detailed view of the host pipe of the composite product of FIG. 11;

FIG. 13 is a schematic sectional view of the moulding apparatus connected to the host pipe of FIG. 12;

FIG. 14 shows a sectional view of a mould for casting a component on a host pipe in a closed position with the seal of the inner mould component in a retracted condition; and

FIG. 15 shows the mould of FIG. 14 with the seal of the inner mould component in an extended condition.

### DETAILED DESCRIPTION OF THE DRAWINGS

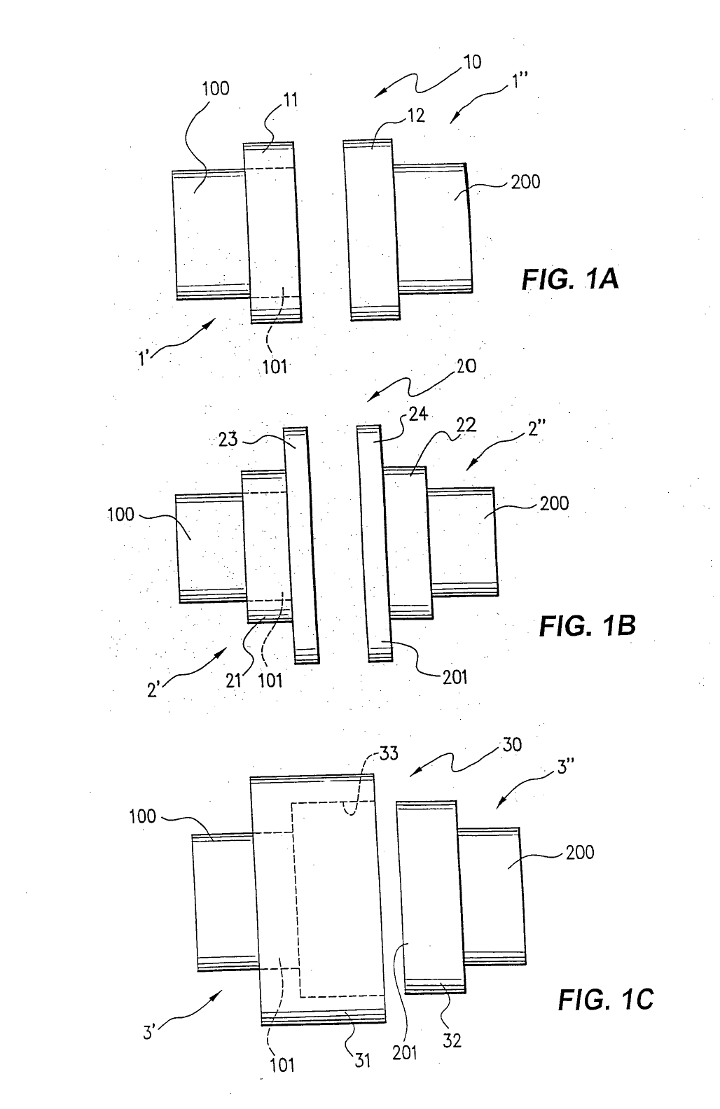

FIGS. 1A to 1C illustrate various couplings 10, and 30 for connecting first and second pipes 100 and 200. The couplings incorporate polymeric components which are moulded to ends of the pipe as will be described in more detail below.

In the illustrated form, the pipes 100 and 200 are formed from sheet steel that incorporates a corrosion resistant coating. Further, the steel may be profiled to include stiffening formations so as to increase the strength of the pipe. These stiffening formations may be in the form of ribs, corrugations or the like. Furthermore, the pipes 100 and 200 may be coated with a polymeric material. This polymeric material may be in the form of a film that provides a moisture barrier and/or enhances the chemical resistance of the sheet metal. Such polymeric films may include low or high density polyethylene, PVC and polypropylene. Further, the polymeric film may facilitate bonding of the polymeric components to the respective pipes.

An example of a pipe that is formed from sheet steel strip, typically having a gauge of between 0.5 mm to 1.6 mm and which includes external ribs that extend helically along the pipe, is sold by the applicant under the trade marks HYDRORIB and AGRIRIB. This pipe incorporates an LD polyethylene film coating sold under the trade mark TRENCHCOAT™LG and is formed by a process of spiral winding the steel strip.

The pipes 100, 200 are arranged to be connected through the couplings 10, 20 and 30 in end to end relationship to provide a fluid seal so as to be able to convey fluid such as water over indefinite lengths. The infrastructure provided by the pipes 100, 200 may be pressure rated for example to supply town water, water for irrigation or gas, or may be non-pressurised and used in applications such as culverts or storm water. The efficacy of the seal formed by the couplings 10, 20 or 30 dictate largely the pressure rating of the pipes.

In the embodiment illustrated in FIG. 1A, the coupling 10 incorporates a first polymeric coupling 11 formed at the end of the first pipe 100 and a second polymeric coupling 12 formed at the end of the other pipe 200. These couplings are arranged to abut one another to form a butt connection between the pipes 100 and 200. A clamping element (not shown) may be disposed over the couplings so as to retain them in position.

In the embodiment illustrated in FIG. 1B, a first coupling 21 is formed on the pipe end 101 whereas a second coupling 22 is formed on the end 201 of the second pipe 200. Each of the couplings includes a flange (23, 24 respectively) at its outer end and these flanges are arranged to butt together in connection of the coupling 20. Whilst not shown, typically fasteners, such as nuts and bolts, extend through the flanges 23 and 24 to maintain the pipes together.

In the embodiment in FIG. 1C, the coupling 30 is of a bell and spigot type with the bell 31 being formed on the end of the pipe 100, and the spigot 32 formed on the end of the other pipe 200. Location of the spigot 32 into the cavity 33 of the bell 31 connects the pipes 100 and 200 together and affects the seal therebetween.

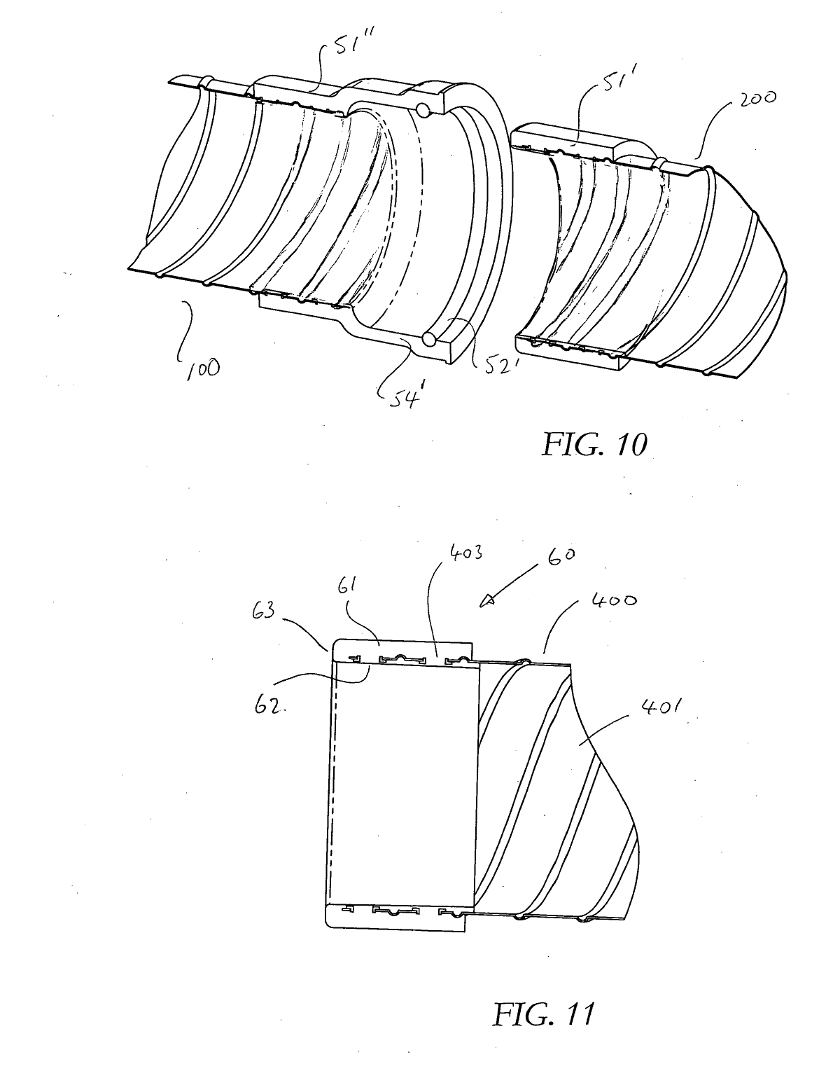

The embodiments of FIGS. 1A to 1C illustrate general coupling types which are ideally formed from polymeric components. As will be appreciated by those skilled in the art, it may be necessary to incorporate seals such as “0” ring seals or pressure seals to provide a watertight joint. An example of such an arrangement is shown in FIGS. 8 to 10.

In the embodiment of FIGS. 8 to 10, a first coupling element (bell) 50^{I} is disposed on the end of one pipe 100 and forms the female component whereas the other coupling element (spigot) 51^{II} is disposed on the end of the other pipe 200 and forms the male connection. A pressure seal 52^{I} is disposed on the female component 50^{I} and is designed to engage with an external surface 53^{II} of the male component 51^{I}. The pressure seal is set partly into a recess 54^{I} formed in an inner surface of the female component 50^{I}.

A joint that is fluid tight is formed by locating the male component 52^{II} into the bore 53^{I} of the female component 50^{I}. The pressure seal 52^{I} forms the fluid seal and is designed to move into tighter engagement with the coupling elements 50^{I} and 51^{II} under increased pressure in the pipes thereby not only increasing the seal but also inhibiting inadvertent release of the pipes. This obviates the need for any separate clamping element to keep the pipe lengths 100, 200 axially aligned.

In addition to the seal formed between the coupling elements, the effectiveness of the coupling to provide a fluid seal will depend to some extent on the interface between the respective polymeric component and the host pipe. The provision of this fluid tight interface between these parts will be described in more detail below.

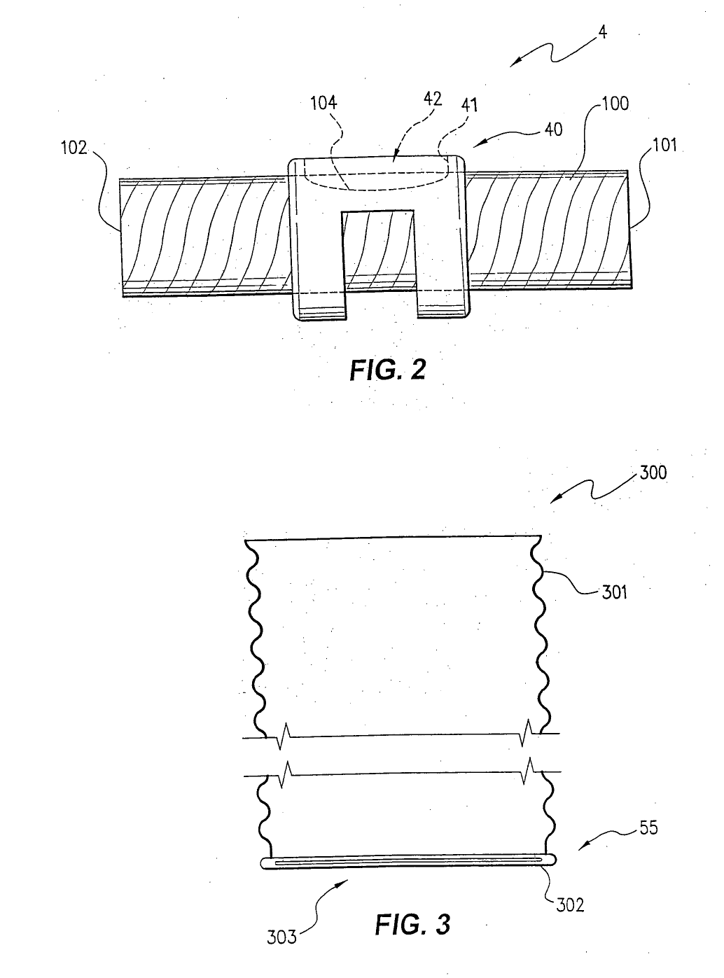

FIG. 2 illustrates a further variation of coupling 40 for a host pipe 100. In this embodiment, the coupling 40 is used to provide a branch line to the pipe 100 and as such, is formed intermediate the ends (101, 102) of the pipe 105. In the illustrated form, the coupling 40 forms a polymeric collar 41 which projects from the pipe surface. This collar 41 defines a central cavity 42 in which an aperture 104 in the underlying pipe wall is located. With this arrangement, a second pipe having a suitable coupling on its end can be connected into the pipe 100 at the coupling 40.

Whilst in one form the coupling 40 may be formed offsite, in an alternate arrangement the coupling may need to be made onsite on an already laid pipe. In that arrangement, the polymeric component 41 is moulded onto the pipe wall, and the aperture 104 is tapped into the pipe onsite.

FIG. 3 illustrates a further type of water infrastructure product, namely a water tank 300. In the embodiment of FIG. 3, the water tank 300 is formed with a cylindrical wall 301 which is made from a profiled sheet metal strip. Again this sheet metal strip may be sheet steel which incorporates a corrosion resistant metal coating and typically incorporate a polymeric coating. An example of a suitable PVC coated sheet steel strip is sold by the applicant under the trade mark AQUAPLATE™. The sheet metal strip typically has a gauge of between 0.5 mm to 1.6 mm and may be profiled with corrugations or ribs and the tank wall may be made from a spiral winding of the sheet strip or in a more conventional configuration, the tank wall is built up by a series of cylindrical panel elements which are disposed one on top of the other.

In the embodiment of FIG. 3, the tank incorporates a polymeric component 55 which is cast onto the bottom of the tank wall 302. This polymeric component forms part of a base assembly 303 for the tank 300.

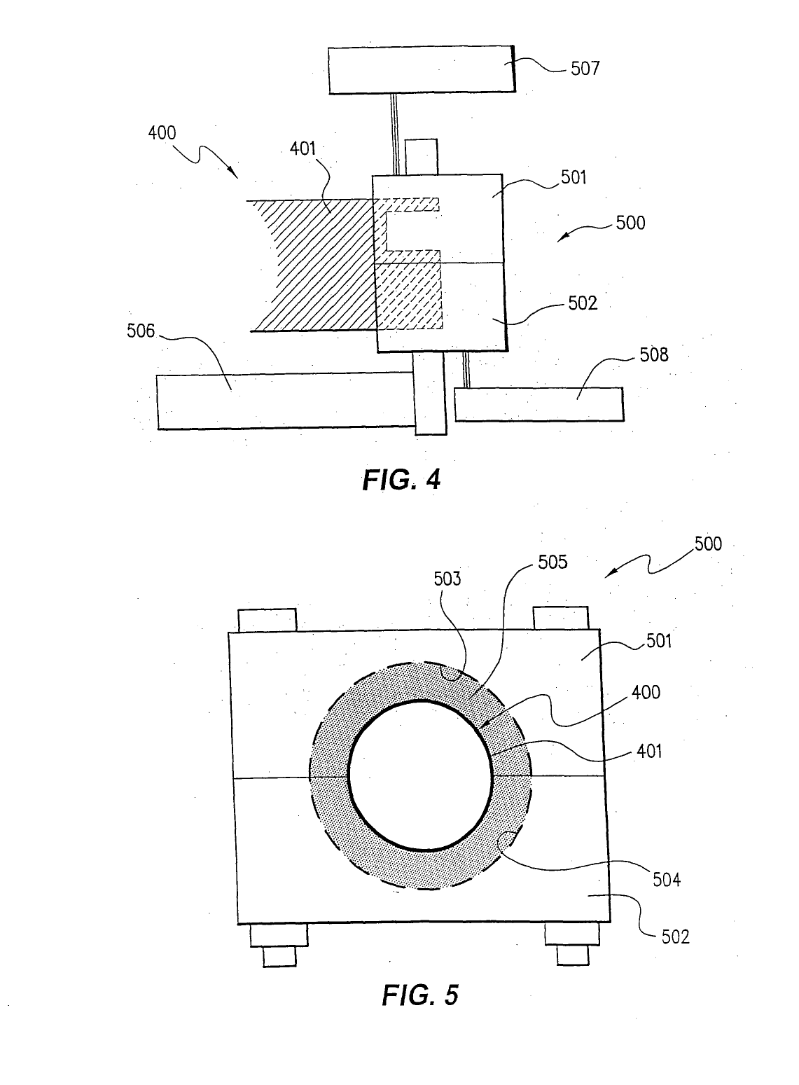

In each of the embodiments illustrated above, the polymeric components are cast directly onto the product section 100, 200 or 300. FIGS. 4 to 16 illustrate different processes for casting in more detail.

Turning firstly to FIGS. 4 and 5, to cast the components onto a product section 400, in a first embodiment a moulding apparatus 500 is provided which incorporates mould parts 501 and 502 which clamp around the product section 400. The mould parts 501, 502 each have an interior mould wall 503 and 504 which when clamped to the product section 400 form, in conjunction with an outer surface 401 of the host section, a closed cavity 505 in which the polymeric material can be introduced.

The apparatus 500 further comprises a feed assembly 506 for introducing the polymeric material into the mould cavity 505. This assembly is typically in the form of an a extruder/injector system which introduces the polymer material in a liquid form under relatively low pressure (typically in the order of 210 kpa-480 kpa) so as not to deform the product section 400. Furthermore, single or multiple injection paths may be used to combine the properties of one or more polymers or other extruded materials to create both a homogenous or heterogenous structures that have an influence upon the physical properties and economics of the final moulded component.

Typically injected polymeric material may be derived from resins associated with polyolefin, ethylene vinyl acetates, poly vinyl chloride, polypropylenes, polycarbonates, nylon and associated blends. These polymeric materials may in addition or alternatively comprise rubber related compounds and may or may not be reinforced by the addition of ceramic or glass beads, directional fibres nanoparticles (such as nanoclays), and/or solid inserts manufactured from polymer or metallic components. The composition of the polymeric material may vary as will be appreciated by persons skilled in the art.

To control the operating parameters of the moulding process, the host section 400 and/or the mould shells 501, 502 may be heated to aid the particular polymer flow characteristics. Typically this will be done via a mould heat apparatus 507. Further, these components may be selectively cooled (by apparatus 508) to control the material flow and shrinkage of the moulded component. In one form, the mould and/or the pipe is cooled to room temperature over a period, typically of less than 15 minutes. Further, a fluid seal may be formed between the mould as the section surface by rapid cooling of the polymeric material in the region of that join. Alternatively a fluid seal may be provided by the use of other sealing arrangements as will be described below.

In addition, gases and or other chemical blowing agents may or may not be added to the polymer material either at the time of formulation or at the point of injection of the polymer to the mould to increase the pressure within the mould to enable the polymeric material to fully take up the shape of the cavity and to control shrinkage of the moulded part and/or the specific filling characteristic of the polymers and the mould cavity.

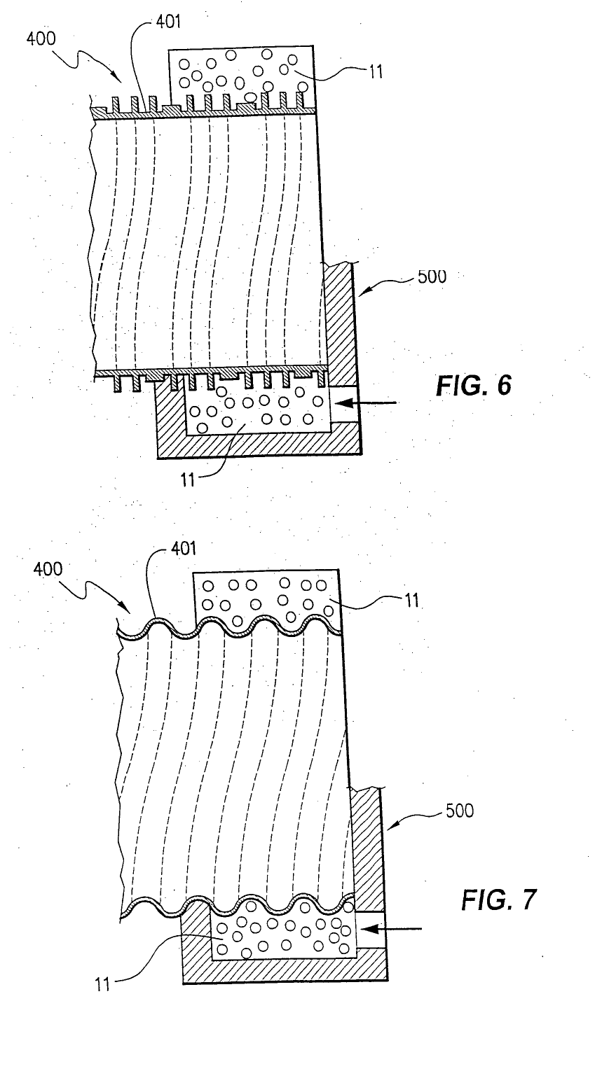

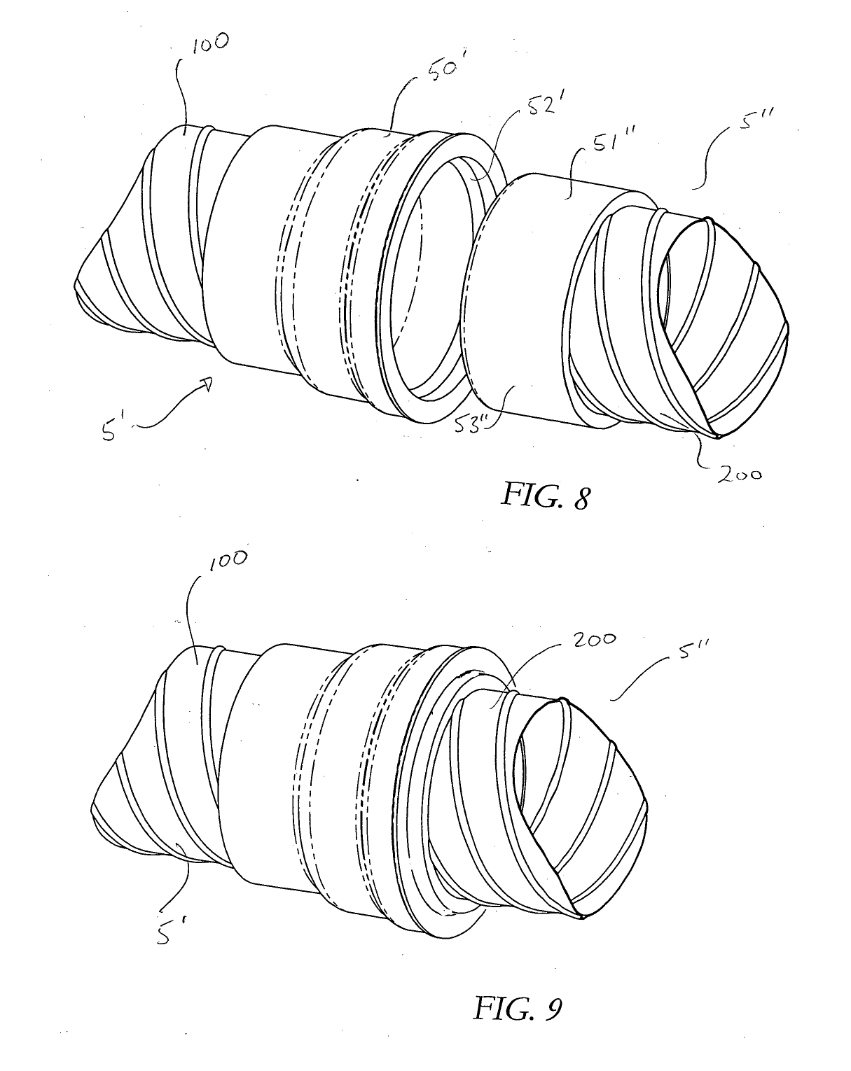

FIGS. 6 and 7 schematically illustrate the moulds 500 shown in the first embodiment when connected to an externally ribbed smooth bore steel pipe whereas in FIG. 7 the host section 400 is a corrugated pipe.

In view of the direct casting of the polymeric component 11 onto the host surface 401 it is possible for the component to precisely take up the shape of that surface so that it is intimately in contact with that surface substantially along the entire interface between those parts. This improves the effectiveness of the interface or joint between these parts to prevent fluid penetration and improves its mechanical strength.

In one form, by choosing appropriate materials, it is possible to achieve a strong bond between the polymeric component and the host section. In one form the polymeric material may bond directly onto a metal surface. Alternatively, the pipe may be pre-coated with a polymeric coating such as that described above so as to enable that coating to bond with the polymeric material of the component. In that arrangement, the coating may be heated to become tacky to assist in formation of the bond between the section and the component. Typically the coating is heated in the range of 90° to 180° and more preferably about 130°.

In addition, if the host section 400 has a profiled outer surface, as illustrated in FIGS. 6 and 7, then the casting of the polymeric components onto that surface provides a mechanical interference which both improves the strength of the connection and also creates a torturous path which can aid in inhibiting fluid penetration through the interface between the parts. This mechanical interference may be improved by the polymeric component shrinking during cooling after it is cast and by bonding on the polymeric coating.

By casting the components onto the host section, it can obviate or at least substantially reduce the need to further shape the components after they have been cast. However, it is to be appreciated that if some complex shapes are required, then some post forming may be necessary. However, in many instances no post forming will be required. This not only provides the advantage of simplifying the process for forming the components and also the equipment that is necessary, but also provides an arrangement where the components can be cast onsite. This is particularly advantageous in water infrastructure where new sections of channels or pipes may be need to be installed and/or new connections made.

Turning to FIGS. 11 to 13, a casting process and apparatus according to a second embodiment is disclosed. This casting process includes many of the steps of the earlier embodiment and in that respect, the disclosure above with reference to the first embodiment is equally applicable to the second embodiment. For example, the casting process is applied to the host section 400, which may or may not be profiled, with moulding apparatus 600 being clamped on the host section 400 to allow the casting of a polymeric component.

As shown schematically in FIG. 11, a male (spigot) end coupling 60 incorporates a first portion 61 which is disposed along the outer surface 401 of the host section 400 and an inner portion 62 which is disposed within the bore of the host section 400. The outer and inner portions (61, 62) of the coupling 60 are integrally formed and are each connected both at a terminal end 63 of the coupling 60 which projects beyond the end of the host section 400 as well as through holes 403 which are formed in the host section 400.

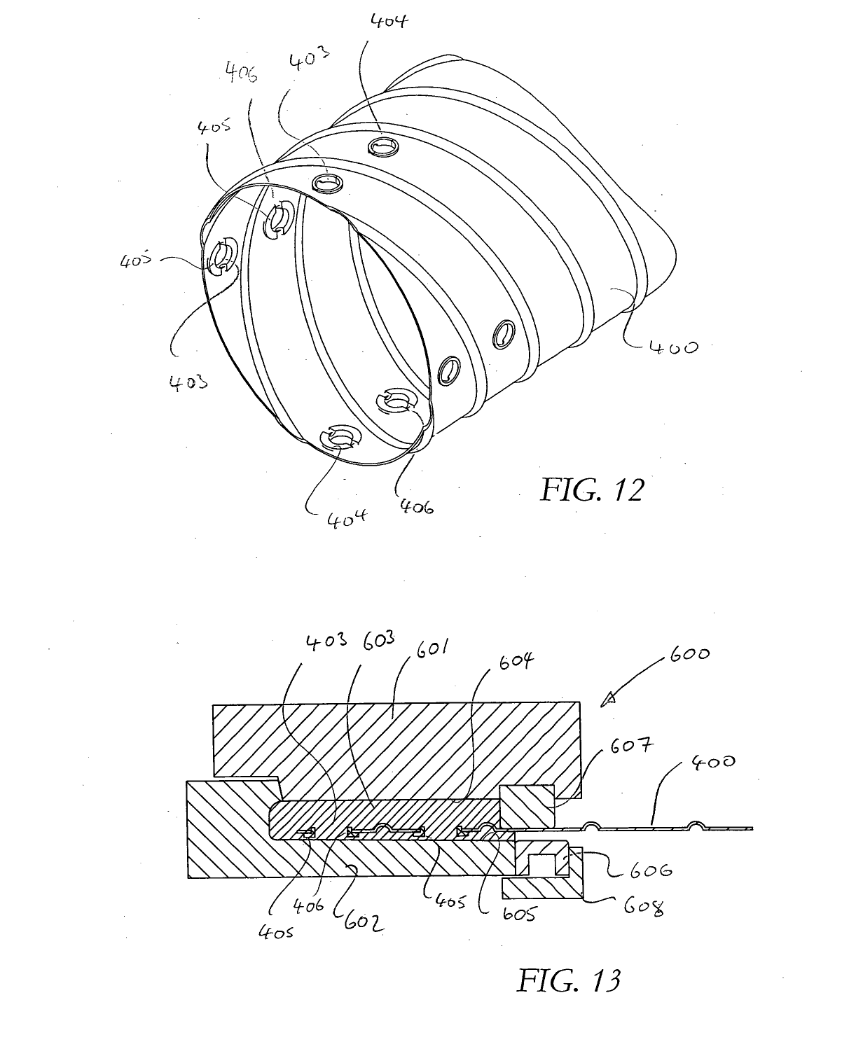

FIG. 12 illustrates the host section prior to casting of the component 60 onto the section end. The host section 400 includes a plurality of the holes 403 which are spaced evenly about the section 400. Typically these holes are punched into the host section and allow the fluid polymeric material introduced in the casting process to be equally presented to both internal and external surfaces of the section 400 so as to allow formation of both the outer and inner (61, 62) portions of the coupling 60.

After formation of the holes 403 within the host section 400, stand off spacers 404 may be inserted into the holes 403. The stand off spacers are typically made from a suitable polymer and provide an access path for the fluid polymer introduced into the cavity of the mould 600. The spacers 404 also include legs 405 which bear against the mould 600 so as to assist in maintaining a constant distance between the host section 400 and the mould 60 so as to correctly locate the host section within the mould 600 as will be discussed below.

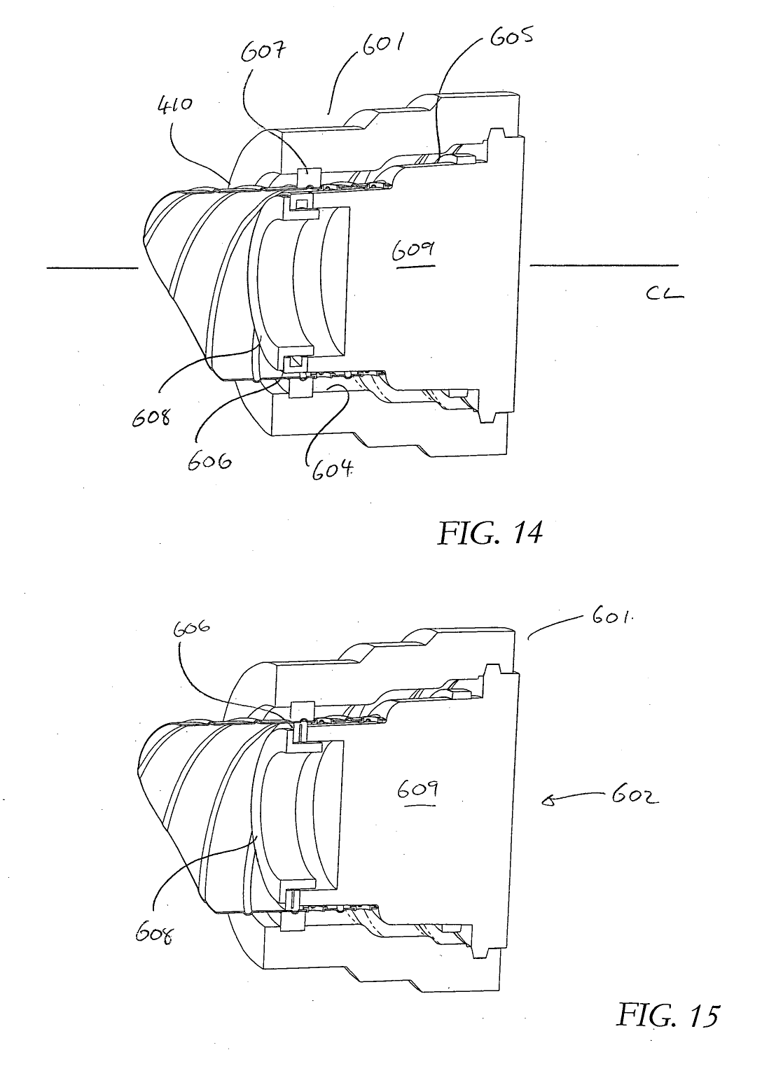

FIG. 13 illustrates the mould set up generally, whilst FIGS. 14 and 15 illustrate the construction of one form of the moulds in more detail. Turing firstly to FIG. 13, the mould 600 includes an outer mould component 601 and an inner mould component 602. The mould cavity 603 which is used to produce the coupling 60 is defined by a cavity part formed by inner surface 604 of the mould component 601 and a cavity part formed by inner surface 605 of the inner mould component 602. In this way, the host section 400 is disposed within the cavity 603 in spaced relation from the respective inner surfaces 604, 605 of the mould component 601, 602. As mentioned above, to maintain the position of the host section 400 within the mould, the legs 405 of the spacers 404 are arranged to bear against at least one of the inner mould surfaces (in the illustrated form being the surface 605). To ensure that the polymeric material introduced into the cavity 603 is able to fully fill the cavity, the legs 405 of the spacers 404 do not extend around the entire circumference of the respective spacers but rather cut outs 406 are provided which provide access ports and facilitate flow of the polymer material around those spacers to fully fill the cavity 603.

Upon introduction of the polymeric material into the cavity 603 the material is able to flow through the apertures and around the host section 40. In this way the pressure on opposing sides of the host section is substantially equalised thereby reducing the likelihood of any deformation of the thin walled host section 400. As such, the pressure at which the polymeric material in liquid form is introduced into the cavity may be greater than in the earlier embodiment. Whereas in the first embodiment the pressure was typically no greater than 480 kpa, in the second embodiment, pressures in the order of 800 kpa or even greater can be used without risk of deformation of the host section 400. A further advantage of the moulding process according to the second embodiment is that the resultant intrusion of the polymer through the holes 403 also provides a positive locking of the moulded coupling 60 onto the post section 400.

During the casting process according to the second embodiment, the same types of polymeric material may be used as disclosed in the earlier embodiment. Furthermore the operating parameters of the moulding process are equally applicable to this second embodiment.

FIGS. 14 and 15 illustrate the construction of the mould 600 in more detail. Turning firstly to FIG. 14, the outer mould 601 locates around the host pipe 400 and is typically formed in two parts (not shown) which are movable between an open condition which allows the host pipe 400 to locate over the inner mould component to a closed condition as illustrated in FIGS. 14 and 15 wherein the mould parts of the outer mould clamp around the end of the host pipe 400.

The mould 600 further includes a sealing arrangement that is engagable with the inner and outer surfaces of the pipe so as to prevent moulding material introduced into the cavity 603 to egress from that cavity. In this respect, the inner mould 602 includes a first seal 606 and the outer mould component 601 includes a second seal 607 which are associated with the respective outer mould parts.

The first seal 606 is disposed at the end of the inner surface 605 which defines the inner wall of the cavity 603. The seal is located between an end piston 608 which is movable relative to the main part 609 of the inner mould component 602 so as to be able to move the seal from a retracted position as shown in FIG. 14 to an extended condition as shown in FIG. 15. In the extended condition the seal 606 is caused to be compressed by movement of the piston 608 towards the main part 609 of the inner mould component 602 which in turn cause radial expansion (relative to the axis CL of the inner mould component). This causes the seal 606 to bias against the inner surface of the host section 400 thereby providing a fluid seal along that inner surface.

An advantage of the first seal arrangement on the inner mould component is that it facilitates movement of the host section 400 on and off the inner mould component 602. In use relative movement occurs between the pipe and the inner mould component 602 in the direction of the mould axis CL so that the host pipe 400 locates over the main part 609 of the inner mould. This relative movement occurs whilst the seal 606 is in its retracted condition thereby ensuring that the seal does not inhibit this relative movement. Once in position the seal can then be moved to its expanded position (as shown in FIG. 16) by the axial movement of the piston 608.

The second seal 607 in the illustrated form is in the form of a deformable polymeric material which is arranged to conform to the profile of the outer surface of the host section when the outer mould 601 is moved from its open condition to its closed condition. In use the seal 607 is in two parts with a respective part located within a recess 610 formed in each part of the outer mould 601. In particular the deformable seal 607 is able to accommodate the stiffening ribs 410 formed on the outer surface of the pipe. In this way an effective fluid seal can be formed along this interface between the outer mould component 601 and the outer surface of the pipe 400.

In use the moulding material is introduced into the cavity 603 through an inlet port (not shown) so as to enable the cavity 603 to be filled. The air from the cavity 603 is able to be vented through an outlet port (not shown). Once the component has been cast on the section 400 and once the coupling has gone through a cooling cycle, the outer mould is opened. The inner seal 606 is also decompressed by movement of the piston 608 away from the main part 609 of the inner mould component 602 thereby allowing the seal to move to its retracted position. The pipe can then be ejected from the inner mould component 602 and a new pipe can then be inserted into the mould for casting of the component onto that host section.

In one variation of the above arrangement, one of the inner, or outer, mould component does not incorporate a cavity but rather is provided merely to support the host pipe during the casting process. In this arrangement, there is no requirement to balance fluid pressure on either sides of the pipe 400. Rather the body is supported during casting by one of the inner or outer core components which acts as a backing support for the body.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Variations and modifications may be made to the parts previously described without departing from the spirit or ambit of the invention.

1-27. (canceled)

28. A method of forming a polymeric component on a body having opposite sides comprising the steps of:
casting fluid polymeric material onto at least one side of the body whilst providing support for said body to resist deforming of the body under the casting pressure; and
providing conditions suitable to cause hardening of the polymeric material to form the polymeric component as a casting on the body.

29. A method according to claim 28, wherein the body is supported by providing fluid pressure on the opposite sides of the body.

30. A method according to claim 29, wherein the fluid pressure on the opposite sides of the body is substantially equal.

31. A method according to claim 29, wherein the polymeric material is cast on the opposite sides of said body so as to provide fluid pressure on said opposite sides.

32. A method according to claim 31, wherein at least one aperture is located in said body to allow the fluid polymeric material to flow between said opposite sides so as to balance the fluid pressure being applied to said opposite sides during casting.

33. A method according to claim 32, further comprising the steps of:
providing a mould cavity having a cavity part on each of opposite sides of the body; the mould cavity parts being interconnected by said at least one aperture;
introducing the fluid polymeric material into at least one of the cavity parts so that the fluid polymeric material is able to flow between said cavity parts via the at least one aperture.

34. A method of forming a polymeric component on a body, the method comprising the steps of:
providing at least one aperture in the body;
providing a mould cavity having a cavity part on each of opposite sides of the body; the mould cavity parts being interconnected by said at least one aperture;
introducing a fluid polymeric material into at least one of the cavity parts so that the fluid polymeric material is able to flow between said cavity parts via the at least one aperture; and
providing conditions suitable to cause hardening of the polymeric material to form the polymeric component as a casting on the body.

35. A method according to claim 34, further comprising the steps of:
providing first and second mould parts, and
disposing the respective ones of the first and second mould parts on opposite sides of the body.

36. A method according to claim 35, wherein one of the first or second mould parts is arranged to support the body during casting.

37. A method according to claim 35, wherein each mould part defines a cavity part.

38. A method according to claim 35, further comprising the steps of:
providing at least one spacer on the body; and
locating said at least spacer on at least one of said mould parts so that said body is supported on said mould part.

39. A method according to claim 38, wherein the at least one spacer is mounted within at least one aperture is located in said body.

40. A method according to claim 35 further comprising the steps;
locating only a portion of the body in the mould formed by said mould parts; and
sealing the mould parts to said body to prevent moulding material introduced into a cavity of the mould to egress from the cavity.

41. A method according to claim 40, wherein at least one mould part is sealed to the body by moving a seal associated with the mould part from a retracted position into an extended position.

42. A method according to claim 34, wherein the body is formed from sheet material.

43. A composite product comprising a body formed from sheet material and incorporating at least one aperture extending through the sheet body, and a polymeric component cast onto at least one surface of the body, the polymeric component being cast over said at least one aperture so that said cast component extends into said at least one aperture.

44. A product according to claim 43, wherein the polymeric component is cast on both sides of said body and the portions of the component on the respective sides of said body are interconnected through said at least one aperture.

45. A product according to claim 43, wherein the component is bonded to the body surface as a result of being cast onto that surface.

46. A product according to claim 43, wherein the body is formed of sheet material and is profiled to include stiffening formations which increase the structural properties of the body.

47. A product according to claim 43, wherein the body is formed from sheet metal.

48. A product according to claim 47, wherein the body is formed from sheet steel that incorporates a corrosion resistant metal coating.

49. A product according to claim 47, wherein the body incorporates a polymeric coating applied to the sheet metal that forms an intermediate layer between the metal sheet and the polymeric component.

50. A product according to claim 47, wherein the product is for water infrastructure, the body being shaped to convey or contain water and a water impermeable interface is formed between the body and the component.

51. A product according to claim 43, wherein the body is in the form of a pipe having a closed section.

52. A product according to claim 51, wherein the pipe includes at lest one external stiffening formation which extend between opposite ends of the pipe.

53. A product according to claim 43, wherein the polymeric component is cast onto the body so as to form a coupling for that body.

54. A product according to claim 53, wherein the coupling is formed at the end of the body.
